(19) United States
(12) Patent Application Publication
(10) Pub. No.: US 2021/0036331 A1
(43) Pub. Date: Feb. 4, 2021

(54) ACTIVE MATERIAL FORMULATION FOR LI-S BATTERY AND PREPARATION PROCESS

(71) Applicant: Arkema France, Colombes (FR)

(72) Inventors: Alexander Korzhenko, Pau (FR); Dominique Plee, Gap (FR)

(73) Assignee: Arkema France, Colombes (FR)

(21) Appl. No.: 16/969,049

(22) PCT Filed: Feb. 19, 2019
(86) PCT No.: PCT/FR2019/050381

§ 371 Date: Aug. 11, 2020

(30) Foreign Application Priority Data
Feb. 19, 2018 (FR) 1851406

(51) Int. Cl. H01M 4/66; H01M 4/62

(52) U.S. Cl. CPC H01M 4/663; H01M 4/136; H01M 4/622; H01M 4/625

(57) ABSTRACT

An active material formulation comprising a sulfur-based material and an electrically conductive composition is described, wherein the electrically conductive composition comprises carbon nanotubes and carbon fibers. A process is also described for preparing the active material formulation, a catholyte comprising the formulation, a cathode comprising the catholyte and an accumulator comprising the cathode.

The invention relates to the field of lithium/sulfur accumulator batteries and more particularly to an active material formulation for the manufacture of a cathode having improved performance, and also to an accumulator including said active material. The invention also relates to a process for preparing such a formulation.

### PRIOR ART

The development of rechargeable batteries with a high energy density is of very great technological and commercial interest. Many systems exist, such as Li-ion batteries equipping portable electronic systems, Ni-MH batteries equipping hybrid vehicles or other technologies.

Lithium/sulfur (Li/S) accumulator batteries or Li/S batteries are envisaged as promising alternatives to Li-ion batteries. The interest in this type of battery arises notably from the high potential energy density of sulfur. In addition, sulfur has the advantages of being abundant, inexpensive and nontoxic, which makes it possible to envisage the large-scale development of Li/S batteries.

The mechanism for discharging and charging an Li/S battery is based on the reduction/oxidation of sulfur at the cathode (S+2e⁻↔S²⁻) and the oxidation/reduction of lithium at the anode (Li↔H Li⁺+e⁻). To enable the electrochemical reactions to take place rapidly at the electrodes, the cathode and the anode must overall be good electron conductors. However, sulfur has relatively slow discharging regimes and, as it is an electrical insulator, it is necessary to give it a conductive nature.

Various improvement routes directed toward overcoming the low electron conductivity of sulfur have been envisaged, notably the addition of an electron-conducting additive, such as a carbon-based conductive material.

Mixing of the active material and of the conductive additive may be performed in various ways. For example, the mixing may be performed during the preparation of the electrode. The sulfur is then mixed with the conductive additive and optionally a binder by mechanical stirring, before shaping the electrode. By virtue of this homogenization step, the carbon-based additive is assumed to be distributed around the sulfur particles, and thus to create a percolating network. A milling step may also be employed and enables more intimate mixing of the materials. However, this additional step may bring about destruction of the porosity of the electrode. Another way of mixing the active material with the carbon-based additive consists in milling the sulfur and the carbon-based additive via the dry route, so as to coat the sulfur with carbon. However, when the carbon-based additive is a carbon nanotube, the introduction of carbon nanotubes into the formulation raises a few problems. This is because they prove to be difficult to handle and to disperse, due to their small size, to their pulverulence and, possibly, when they are obtained by chemical vapor deposition (CVD), to their entangled structure furthermore generating strong Van Der Waals interactions between them. The low dispersion of the nanotubes limits the efficiency of the charge transfer between the positive electrode and the electrolyte and thus the performance of the Li/S battery, despite the addition of a mass of the conductive material.

The Applicant has discovered that an active material can also be obtained by placing carbon nanotubes (referred to hereinbelow as CNTs) in contact with a sulfur-based material via the molten route, for example in a compounding device, thus forming an improved active material which can be used for the preparation of an electrode (WO 2016/102865).

In this case, the sulfur-based material is combined with carbon-based nanofillers such as CNTs, graphene or carbon black in a blending tool at the melting point of the sulfur-based material. This enables the production of a sulfur-carbon composite which may be in the form of compact granules. These granules are then milled under an inert atmosphere so as to obtain a powder which can be used for the manufacture of the cathode.

Despite the advantages of Li—S batteries and these novel processes enabling the formation of a more homogeneous active material, Li—S batteries continue to suffer from a relatively rapid reduction in cycling capacity.

The reduction in cycling capacity is multi-factorial. It notably involves the formation of several lithium polysulfides during discharging, which become dissolved in the electrolyte and escape from the cathode. The decline in capacity also takes place via passivation effects and the formation of insoluble sulfides, amplified by the volume variations during discharging, which causes mechanical tensions and loss of contacts with the current collector.

Numerous methods have been proposed to improve the cycling. For example, the effects of MWNT (Multi-Walled NanoTubes) and of graphite nanofibers (GNF) on the cathode performance of Li—S batteries have been studied (Kim Jong-Hwa, et al., Materials Science Forum, 2005, 486-487). MWNTs or GNFs were added as additives to the electrode, composed of 60% sulfur, 20% acetylene black, 5% MWNT or GNF and 15% PEO (poly(ethylene) oxide), dissolved in acetonitrile.

The addition of MWNT or of GNF gives better electrochemical properties, but the improvement remains limited, since, after 50 cycles, the capacity is only 130 mAh/g with carbon blacks, 250 mAh/g with carbon blacks plus GNF and 300 mAh/g with carbon blacks plus MWNT for initial capacities of about 700 mAh/g.

A solution was also proposed based on the combination of nanotubes with other carbon-based fillers such as carbon black, graphene or graphene oxide. For example, an Li₂S— carbon nanostructured composite obtained by dry ball milling of micron-sized Li₂S powder in the presence of carbon blacks is used with carbon nanotubes and a simple method of electrochemical activation to improve the use and the reversibility of the electrodes in the presence of nanotubes.

Methods comprising carbon nanotubes and carbon nanofibers have also been developed for the purpose of increasing battery performance. However, these methods as described in CN 106450191 showed maintenance of performance only on a relatively low cycling number. The method described in CN 107221660 comprising the combination of carbon nanofibers and of nanotubes showed, for its part, that in the presence of carbon nanotubes, the presence or absence of carbon nanofibers generates similar results.

Another method taught in US 2011/0165462 also discloses the use of nanotubes combined with carbon nanofibers with a diameter of less than 100 nm, for the manufacture of electrodes by rolling up sheets. These techniques make it possible to withstand the formation of dendrites for improving the performance of a battery.

Finally, carbon nanotubes and carbon nanofibers have also been combined in order to make electrodes including an infiltration of sulfur into micropores (<2 nm) and thus making it possible to increase the capacity and the cycling stability (Linchao Zeng et al. Free-standing porous carbon nanofibers-sulfur composite for flexible Li—S battery cathode, 2014, Vol. 6, 9579-9587).

Despite the improvements in cycling obtained with the methods of the prior art, there is a need for active material formulations for further improving the cycling stability of Li/S electrodes.

In addition, there is a need for an active material formulation for increasing the charging and discharging capacity of the battery incorporating this active material.

### TECHNICAL PROBLEM

The invention thus aims to overcome the drawbacks of the prior art. In particular, the aim of the invention is to propose a formulation for manufacturing an electrode which has improved cycling stability.

The aim of the invention is also to propose a process for preparing a formulation for manufacturing an electrode, said process being rapid and simple to perform, and enabling an increase in the charging and discharging capacity of the battery incorporating this active material.

### BRIEF DESCRIPTION OF THE INVENTION

To this end, the invention relates to an active material formulation comprising a sulfur-based material and an electrically conductive composition including carbon nanotubes and at least one other carbon-based filler selected from carbon nanofibers and carbon fibers.

Preferably, the invention relates to an active material formulation comprising a sulfur-based material and an electrically conductive composition, characterized in that the electrically conductive composition comprises carbon nanotubes and carbon fibers.

The performance of the batteries can be improved by using an electrically conductive composition according to the invention. The active material for Li—S cathodes is generally based on sulfur and carbon. Generated according to the methods of the prior art, it generally has poor cycling stability and in particular poor dimensional stability. Specifically, the active material may suffer damage during charging and discharging cycles, the consequence of which is a degradation in the performance of the battery incorporating said active material.

Thus, the Applicant has developed a novel formulation for increasing the performance of batteries, notably by enabling improved cycling stability. The formulation according to the invention may be used as cathode active material of a lithium/sulfur accumulator.

Specifically, the Applicant has found an active material comprising a conductive composition containing at least carbon nanotubes, in combination with carbon nanofibers and/or carbon fibers, preferably in combination with carbon fibers, which can be dispersed homogeneously and form a three-dimensional nanotube network in the bulk of a sulfur-based material, this active material making it possible to increase the stability and the charging and discharging capacity of the battery incorporating this active material. Unlike carbon black, additives of carbon nanotube type have the advantage of also conferring an adsorbent effect that is beneficial to the active material by limiting its dissolution in the electrolyte and thus promoting better cyclability. In addition, the addition of a second population of carbon-based additives, such as carbon fibers, and optionally of a third population of carbon-based additives, which are coarser than nanotubes, makes it possible to profit from stability synergism of the conductive network in the bulk of the cathode notably when said cathode is thick (for example beyond 100 μm).

The advantage of combining the two types of material is that the nanofibers and even more so the carbon fibers, which have a larger diameter, can act as main conduction pathways whereas the nanotubes act as secondary conductors over shorter distances where the quality of dispersion is less problematic.

According to other optional features of the active material formulation:
The electrically conductive composition comprises carbon nanotubes, carbon nanofibers and carbon fibers. The best performance is obtained with the combination of these three carbon-based fillers.
The electrically conductive composition also comprises another carbon-based filler selected from: carbon blacks, acetylene blacks, graphites, graphenes, active charcoals, and mixtures thereof.
The sulfur-based material and the electrically conductive composition are in a mass ratio of between 1/4 and 50/1.
The carbon nanotube content is at least 20% by weight of the conductive composition.
At least a portion of the carbon nanofibers, carbon nanotubes and/or carbon fibers is covered with an intrinsically conductive polymer. In particular, at least a portion of the carbon nanotubes and/or carbon fibers is covered with an intrinsically conductive polymer.
At least a portion of the carbon nanofibers, carbon nanotubes and/or carbon fibers is covered with an ion-conducting ceramic material. In particular, at least a portion of the carbon nanotubes and/or carbon fibers is covered with an ion-conducting ceramic material.
The sulfur-based material has an S8 content of less than 10% by weight of the sulfur-based material.

The invention also relates to a process for preparing the active material formulation according to the invention, including a step of placing the sulfur-based material in contact with the electrically conductive composition.

According to other optional features of the process:
The step of placing in contact is selected from: mixing the sulfur-based material with the electrically conductive composition at a temperature greater than or equal to the melting point of the sulfur-based material, sublimation of the sulfur-based material on the electrically conductive composition, liquid-phase deposition of the sulfur-based material on the electrically conductive composition.
The process includes a preliminary step of forming a sulfur-carbon composite, said preliminary step of forming the sulfur-carbon composite including melting of a sulfur-based material and blending of the molten sulfur-based material and of the carbon-based fillers, preferably in a compounding device. The presence in the formulation of a sulfur-carbon composite obtained via the molten route makes it possible to improve the performance of the cathode since such a composite is more efficient than a sulfur-carbon composite obtained, for example, by co-milling of sulfur and carbon. The sulfur-carbon composite may be obtained by melting a sulfur-based material and blending the molten sulfur-based material and carbon-based nanofillers.
The process comprises a step of milling the sulfur-carbon composite, said milling step possibly being performed in a jar mill (horizontal and vertical with a cage), a cavitator, a jet mill, a fluidized bed jet mill, a liquid-phase mill, a screw disperser, a brush mill, a hammer mill, a ball mill, or by other micronization methods.
The process comprises the following steps:
   the introduction into a milling device of a liquid-phase solvent and of
   sulfur-carbon composite, said sulfur-carbon composite including at least one sulfur-based material and carbon-based fillers,
   the implementation of a milling step,
   the production, following said milling step, of a formulation in the form of a solid-liquid dispersion including the sulfur-carbon composite, and
   the optional implementation of a drying step.
Performing milling in the presence of a liquid-phase solvent makes it possible to improve the performance of the formulation relative to dry milling under an inert atmosphere according to the methods of the prior art.

The invention also relates to a catholyte comprising the active material formulation according to the invention and a binder. Such a catholyte is capable of maintaining a substantially constant capacity even after a large number of charging/discharging cycles and thus of preserving the capacity of an Li—S battery over time.

According to another optional characteristic, the catholyte also comprises at least one additive chosen from: a rheology modifier, an ion conductor, another carbon-based electrical conductor, an electrolyte and an electron-donating element.

The invention also relates to the use of the formulation according to the invention for manufacturing a cathode. More particularly, the invention also relates to a cathode prepared from the active material formulation according to the invention or from a catholyte according to the invention. The active material formulation according to the invention makes it possible to improve the electron conductivity of the electrode formulation, the mechanical integrity of the electrode and thus the functioning over time of the battery.

The invention also relates to a lithium/sulfur accumulator comprising a cathode according to the invention. The active material formulation has a better combination of a sulfur-donating material, with a 3D network of carbon-based fillers to facilitate the access of sulfur to the electrochemical reactions, which can contribute toward good maintenance of the functioning of the battery over time.

Other advantages and features of the invention will become apparent on reading the following description given by way of illustrative and nonlimiting example, with reference to the appended figures, which depict:

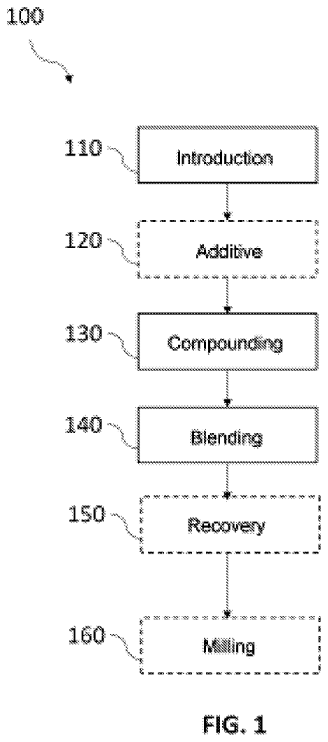

FIG. 1: a schematic representation of a process for preparing an active material formulation in accordance with the invention. The steps with dashed lines are optional.

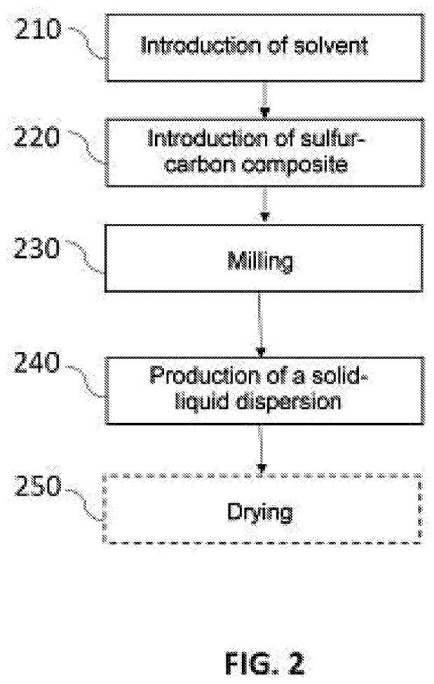

FIG. 2: a schematic representation of a preferred milling process according to the invention.

### DESCRIPTION OF THE INVENTION

In the continuation of the description, the term “active material” refers to the compounds that are capable of ensuring efficient transfer of electricity from the current collector of the electrode and of offering active interfaces to the electrochemical reactions during the functioning of the battery. More particularly, this corresponds to the compounds with which the lithium ions are capable of reacting, and from which the lithium ions are capable of being released. Thus, preferably, in the context of the invention, the active material corresponds to the sulfur-based material. Thus, for the purposes of the invention, the term “active material formulation” means a mixture of different substances notably including the active material.

The term “sulfur-based material” means a sulfur-donating compound chosen from native (or elemental) sulfur, sulfur-based organic compounds or polymers and sulfur-based inorganic compounds.

The term “sulfur in elemental form” or “elemental sulfur” means sulfur particles in a crystalline S8 form or in an amorphous form. More particularly, this corresponds to sulfur particles in elemental form not including any sulfur associated with carbon originating from the carbon-based fillers.

The term “electrically conductive composition” means a composition including compounds or structures that are capable of conducting an electrical current.

The term “catholyte” means a composition including the components which form a cathode.

The term “carbon-based filler” may denote a filler comprising at least one element from the group formed from carbon nanotubes, carbon nanofibers, carbon fibers, carbon blacks, acetylene blacks, graphites, graphenes and active charcoals. The term “filler” usually denotes a carbon-based filler, the smallest dimension of which is between 0.1 and 20 μm, preferably between 0.1 and 15 μm, more preferably between 0.1 and 10 μm and even more preferably between 0.2 and 10 μm. The term “nanofiller” usually denotes a carbon-based filler, the smallest dimension of which is between 0.1 and 200 nm, preferably between 0.1 and 100 nm and more preferably between 0.1 and 50 nm, measured by light scattering.

The term “solvent” means a substance, which is liquid or supercritical at its working temperature, and which has the property of dissolving, diluting or extracting other substances without chemically modifying them and without itself becoming modified. The “liquid-phase solvent” is a solvent in liquid form.

The term “sulfur-carbon composite” means an assembly of at least two immiscible components whose properties complement each other, said immiscible components including a sulfur-based material and a carbon-based filler.

According to the invention, the term “compounding device” refers to an apparatus conventionally used in the plastics industry for melt mixing thermoplastic polymers and additives for the purpose of producing composites. In this apparatus, the sulfur-based material and the carbon-based fillers are mixed by means of a high-shear device, for example a co-rotating twin-screw extruder or a co-kneader. The molten material generally leaves the apparatus in an agglomerated solid physical form, for example in the form of granules.

For the purposes of the invention, the expression “substantially constant” corresponds to a value varying by less than 20% relative to the compared value, preferably by less than 10% and even more preferably by less than 5%.

The invention is now described in greater detail and in a nonlimiting manner in the description that follows. In the description hereinbelow, the same references are used to indicate the same elements.

As is presented in the examples, the inventors have developed a combination of a sulfur-based material with a particular electrically conductive composition which makes it possible to improve the maintenance of the cycling capacity and the dimensional stability.

Thus, the inventors have developed an active material formulation, which can be used for the manufacture of an electrode, comprising a sulfur-based material and an electrically conductive composition including carbon nanotubes and at least one other carbon-based filler selected from carbon nanofibers and carbon fibers. Preferably, the electrically conductive composition comprises carbon nanotubes and carbon fibers. The electrically conductive composition may then also comprise carbon nanofibers. As presented in the examples, such a formulation is capable of maintaining a virtually constant capacity even after a large number of charging/discharging cycles and thus of preserving the capacity of an Li—S battery over time.

The inventors have determined that the electrically conductive composition must include carbon nanotubes in combination with one and/or the other from among carbon nanofibers and carbon fibers. Preferably, the electrically conductive composition comprises carbon nanotubes and carbon fibers.

However, they have also shown that, preferably, the electrically conductive composition comprises carbon nanotubes, carbon nanofibers and carbon fibers. Specifically, the combination of at least these three carbon-based fillers gives the best results in terms of maintaining the cycling capacity. Specifically, at least two populations of carbon-based fillers in the form of fibrils ensure better dimensional stability of the cathode with respect to volume changes between charging and discharging.

The conductive composition may include from 1% to 99% of carbon nanotubes and from 1% to 99% of carbon fibers. In particular, the electrically conductive composition comprises at least 20% of carbon nanotubes of single-walled, double-walled or multi-walled type, preferably at least 30% of carbon nanotubes, more preferably at least 40% of carbon nanotubes and even more preferably at least 50% of carbon nanotubes.

In addition, the sulfur-based material and the electrically conductive composition are preferably in a mass ratio of between 1/4 and 50/1. More preferably, the sulfur-based material and the electrically conductive composition are in a mass ratio of between 2/1 and 20/1 and even more preferably between 4/1 and 15/1.

According to the invention, the carbon nanotubes may be single-walled carbon nanotubes (SWNT), double-walled carbon nanotubes (DWNT) or multi-walled carbon nanotubes (MWNT); they are preferably multi-walled. The carbon nanotubes used according to the invention usually have a mean diameter ranging from 0.1 to 100 nm, preferably from 0.1 to 50 nm, more preferentially from 1 to 30 nm, or even from 10 to 15 nm, and advantageously have a length of 0.1 micron or more and advantageously from 0.1 to 20 microns, preferably from 0.1 to 10 microns.

The length/diameter ratio of the carbon nanotubes, or aspect ratio, is advantageously greater than 10 and usually greater than 100. Their specific surface area is, for example, between 50 and 300 m²/g, advantageously between 100 and 300 m²/g, and their apparent density may notably be between 0.01 and 0.5 g/cm³ and more preferentially between 0.07 and 0.2 g/cm³. The MWNTs may comprise, for example, from 5 to 25 walls and more preferentially from 7 to 20 sheets.

The carbon nanotubes are notably obtained by chemical vapor deposition (CVD), for example according to the process described in WO 06/082325. Preferably, they are obtained from renewable starting material, in particular of plant origin, as described in patent application EP 1 980 530.

An example of carbon nanotubes is found under the trade name Graphistrength® C100 from the company Arkema. These nanotubes may be purified and/or treated (for example oxidized) and/or milled and/or functionalized. The milling of the nanotubes may be performed under cold or hot conditions and may be performed according to the known techniques, performed in apparatus such as ball mills, hammer mills, edge runner mills, knife mills or gas jet mills or any other milling system that is capable of reducing the size of the entangled network of nanotubes. It is preferable for the milling to be performed according to a gas jet milling technique and in particular in an air jet mill.

The crude or milled nanotubes may be purified by washing using a sulfuric acid solution, so as to free them from possible residual mineral and metallic impurities, for instance the catalyst originating from their preparation process. The weight ratio of the nanotubes to the sulfuric acid may be between 1:2 and 1:3. The purification operation may moreover be performed at a temperature ranging from 90° C. to 120° C., for example for a period of from 5 to 10 hours. This operation may advantageously be followed by steps in which the purified nanotubes are rinsed with water and dried.

It is clear that any other relatively strong acid may be suitable for use. Oxidizing acids such as nitric acid, in addition to removing a large part of the mineral materials, will create polar surface functions by surface oxidation of the outer layer.

As a variant, the nanotubes may be purified by high-temperature heat treatment, typically above 1000° C. As an alternative, the carbon nanotubes may be pre-compacted before being subjected to a heat treatment, according to the method described in patent application WO 2018/178929.

Oxidation of the nanotubes is advantageously performed by bringing them into contact with a sodium hypochlorite solution containing from 0.5% to 15% by weight of NaOCl and preferably from 1% to 10% by weight of NaOCl, for example in a weight ratio of the nanotubes to the sodium hypochlorite ranging from 1:0.1 to 1:1. The oxidation is advantageously performed at a temperature below 60° C. and preferably at room temperature, for a period ranging from a few minutes to 24 hours. This oxidation operation may advantageously be followed by steps in which the oxidized nanotubes are filtered and/or centrifuged, washed and dried.

Use is preferably made in the present invention of crude, optionally milled carbon nanotubes, that is to say nanotubes which are neither oxidized nor purified nor functionalized and which have not undergone any other chemical and/or heat treatment.

The carbon nanotube content may be between 1% and 99% by weight of the electrically conductive composition. Advantageously, and as presented in the examples, the electrically conductive composition includes more than 20% of carbon nanotubes and more preferably 40% or more of carbon nanotubes. For example, it includes between 25% and 75% of carbon nanotubes.

The carbon nanofibers or carbon nanofibrils that may be used in the present invention are also nanofilaments produced by chemical vapor deposition (CVD) from a carbon-based source decomposed on a catalyst including a transition metal (Fe, Ni, Co, Cu), in the presence of hydrogen, at temperatures of from 500 to 1200° C., like carbon nanotubes. However, these two carbon-based fillers differ in their structure, since carbon nanofibers are composed of more or less organized graphite regions (or turbostratic stacks), the planes of which are inclined at variable angles relative to the axis of the fiber. These stacks may take the form of platelets, fishbones or stacked dishes to form structures with a diameter generally ranging from 50 nm to 500 nm or even more. Examples of carbon nanofibers that may be used in particular have a diameter of from 100 to 200 nm, for example about 150 nm, and advantageously a length of from 5 to 100 microns and preferably a length of from 5 to 75 microns. Use may be made, for example, of the VGCF nanofibers from Showa Denko.

Thus, the carbon nanofibers contained in the electrically conductive composition preferably have an aspect ratio, i.e. the ratio between the length and the diameter, of between 10 and 2000.

Advantageously, and as presented in the examples, the electrically conductive composition includes more than 20% of carbon nanofibers and more preferably 40% or more of carbon nanofibers. For example, it includes between 25% and 75% of carbon nanofibers.

The carbon fibers that may be used in the present invention are filled or partially porous carbon fibers, which are at least partly graphitized, with diameters preferably of between 200 nm and 20 pm, preferably between 500 nm and 20 pm and even more preferably a diameter ranging from 500 nm to 8 microns. In the family of carbon fibers, there is a preference for ex-cellulose or pitch fibers of reduced diameter (<5 μm), which will be more favorable for avoiding an excessive thickness and electrode architecture defects.

The carbon fibers contained in the electrically conductive composition preferably have an aspect ratio, i.e. the ratio between the length and the diameter, of between 5 and 1000.

In addition, the carbon fibers that may be used in the present invention advantageously have a specific density of between 1.3 and 1.9 g/cm³.

Advantageously, and as presented in the examples, the conductive composition includes more than 20% of carbon fibers and more preferably 40% or more of carbon fibers. For example, it includes between 25% and 75% of carbon fibers. In particular, the conductive composition includes at least 20% of carbon fibers, preferably at least 30% of carbon fibers and more preferably 40% of carbon fibers.

More preferably, the electrically conductive composition includes more than 20% of carbon nanotubes and more than 20% of another carbon-based filler selected from: carbon nanofibers and carbon fibers. Even more preferably, the electrically conductive composition includes more than 20% of carbon nanotubes, more than 20% of carbon nanofibers and more than 20% of carbon fibers.

So as to improve the electrical properties thereof, the carbon nanotubes, the carbon nanofibers and/or the carbon fibers may undergo a surface treatment. Thus, advantageously, at least a portion of the carbon nanofibers, carbon nanotubes and/or carbon fibers is covered with an intrinsically conductive polymer, such as polyaniline, polythiophene, polypyrrole, etc. Alternatively, at least a portion of the carbon nanofibers, carbon nanotubes and/or carbon fibers is covered with an ion-conducting ceramic material.

Although good results have been obtained with carbon nanotubes and at least one other carbon-based filler selected from carbon nanofibers and carbon fibers, the active material formulation may also comprise another carbon-based filler selected from: carbon blacks, acetylene blacks, graphites, graphenes, active charcoals, and mixtures thereof, preferably graphenes.

The term “graphene” denotes a flat, isolated and individualized graphite sheet but also, by extension, an assembly comprising between one and a few tens of sheets and having a flat or more or less wavy structure. This definition thus encompasses FLGs (Few Layer Graphene), NGPs (Nanosized Graphene Plates), CNSs (Carbon NanoSheets) and GNRs (Graphene NanoRibbons). On the other hand, it excludes carbon nanotubes and nanofibers, which consist, respectively, of the winding of one or more graphene sheets coaxially and of the turbostratic stacking of these sheets. Furthermore, it is preferable for the graphene used according to the invention not to be subjected to an additional step of chemical oxidation or of functionalization.

The graphene used according to the invention is obtained by chemical vapor deposition or CVD, preferably according to a process using a pulverulent catalyst based on a mixed oxide. It is characteristically in the form of particles with a thickness of less than 50 nm, preferably of less than 15 nm and more preferably of less than 5 nm, and with lateral dimensions of less than a micron, preferably from 10 nm to less than 1000 nm, more preferably from 50 to 600 nm, or even from 100 to 400 nm. Each of these particles generally contains from 1 to 50 sheets, preferably from 1 to 20 sheets and more preferably from 1 to 10 sheets, or even from 1 to 5 sheets, which are capable of being separated from each other in the form of independent sheets, for example during an ultrasonication treatment.

The sulfur-based material may be elemental sulfur or a sulfur-based molecule such as a sulfur-based organic compound or polymer, or a sulfur-based inorganic compound, or a mixture thereof in all proportions. The sulfur-based inorganic compounds that may be used as sulfur-based materials are, for example, alkali metal anionic polysulfides, preferably the lithium polysulfides represented by the formula Li₂Sₙ (with n greater than or equal to 1). Preferably, the sulfur-based material comprises elemental sulfur.

Various sources of native sulfur are commercially available. The sulfur may be used as is or the sulfur may be purified beforehand according to different techniques, such as refining, sublimation or precipitation. The sulfur or more generally the sulfur-based material may also be subjected to a preliminary step of milling and/or screening in order to reduce the size of the particles and to narrow their distribution. The particle size of the powder may vary within wide limits.

The sulfur-based inorganic compounds that may be used as sulfur-based materials are, for example, alkali metal anionic polysulfides, preferably the lithium polysulfides represented by the formula Li₂Sₙ (with n≥1).

The sulfur-based organic compounds or polymers may be chosen from organic polysulfides, organic polythiolates including, for example, functional groups, such as dithioacetal, dithioketal or trithioorthocarbonate, aromatic polysulfides, polyethers, polysulfides, salts of polysulfide acids, thiosulfonates [—S(O)z-S—], thiosulfinates [—S(O)—S—], thiocarboxylates [—C(O)—S—], dithiocarboxylates [—RC(S)—S—], thiophosphates, thiophosphonates, thiocarbonates, organometallic polysulfides or mixtures thereof.

Examples of such organosulfur compounds are notably described in WO 2013/155038.

According to a particular embodiment of the invention, the sulfur-based material is an aromatic polysulfide.

Aromatic polysulfides correspond to the general formula (I) below:

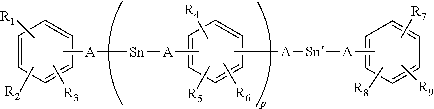

in which:
R₁ to R₉, which may be identical or different, represent a hydrogen atom, an —OH or —O⁻M⁺ radical, a saturated or unsaturated carbon-based chain including from 1 to 20 carbon atoms or a group —OR₁₀, with R₁₀ possibly being an alkyl, arylalkyl, acyl, carboxyalkoxy, alkyl ether, silyl or alkylsilyl radical including from 1 to 20 carbon atoms,
M represents an alkali metal or alkaline-earth metal,
n and n′, which may be identical or different, are two integers, each being greater than or equal to 1 and less than or equal to 8,
p is an integer between 0 and 50,
and A is a nitrogen atom, a single bond or a saturated or unsaturated carbon-based chain of 1 to 20 carbon atoms.

Preferably, in formula (I):
R₁, R₄ and R₇ are radicals O⁻M⁺,
R₂, R₅ and R₈ are hydrogen atoms,
R₃, R₆ and R₉ are saturated or unsaturated carbon-based chains including from 1 to 20 carbon atoms, preferably from 3 to 5 carbon atoms,
the mean value of n and of n′ is about 2,
the mean value of p is between 1 and 10, preferably between 3 and 8. (These mean values are calculated by a person skilled in the art from proton NMR data and by assaying the sulfur by weight).
A is a single bond connecting the sulfur atoms to the aromatic rings.

Such poly(alkylphenol) polysulfides of formula (I) are known and can be prepared, for example, in two steps:

1) reaction of sulfur monochloride or sulfur dichloride with an alkylphenol, at a temperature of between 100 and 200° C., according to the following reaction:

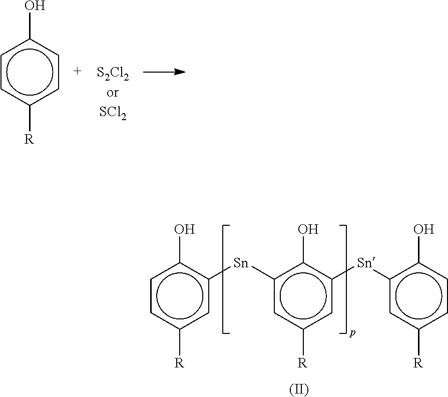

The compounds of formula (II) are notably sold by the company Arkema under the name Vultac®.

2) reaction of compound (II) with a metal derivative containing the metal M, for instance an oxide, a hydroxide, an alkoxide or a dialkylamide of this metal, to obtain radicals O⁻M⁺.

According to a more preferred variant, R is a tert-butyl or tert-pentyl radical.

According to another preferred variant of the invention, use is made of a mixture of compounds of formula (I) in which two of the radicals R present on each aromatic unit are carbon-based chains comprising at least one tertiary carbon via which R is connected to the aromatic nucleus.

The sulfur-based material used in the active material formulation according to the invention may have various heat of fusion values. This heat of fusion (Δ H_{fus}) may preferably be between 70 and 100 J.g⁻¹. Specifically, the sulfur-based material, for example in elemental form or in the form of a polysulfide, may be characterized by a heat of fusion measured during a phase transition (melting) by differential scanning calorimetry (DSC) of between 80° C. and 130° C. Following the implementation of a preparation process according to the invention, and notably the incorporation of the carbon-based fillers via the molten route, there is a decrease in the enthalpy value (Δ H_{fus}) of the composite relative to the enthalpy value of the original sulfur-based material.

In addition, preferably, the sulfur-based material has an S8 content of less than 10% by weight of the sulfur-based material. The S8 content may be measured by DSC.

According to another aspect, the invention relates to a process for preparing the active material formulation. This process includes a step of placing the sulfur-based material in contact with the electrically conductive composition.

The step of placing in contact according to the invention may be performed in many ways. Preferably, the step of placing in contact is selected from: mixing the sulfur-based material with the electrically conductive composition at a temperature greater than or equal to the melting point of the sulfur-based material, sublimation of the sulfur-based material on the electrically conductive composition, and liquid-phase deposition of the sulfur-based material on the electrically conductive composition, the sulfur-based material then being dissolved in a suitable solvent.

The present invention provides a process for obtaining an active material formulation which has a better combination of a sulfur-donating material, with particles of carbon-based fillers to facilitate the access of sulfur to the electrochemical reactions, which can contribute toward good maintenance of the functioning of the battery over time. The active material according to the invention may take the form of a finished product in the solid state comprising a mixture of particles including the electrically conductive composition dispersed in the bulk of the sulfur-based material, in a homogeneous manner. In this case, the active material advantageously has a density of greater than 1.4 g/cm³, determined according to the standard NF EN ISO 1183-1. The density is generally less than 2 g/cm³. It also advantageously has a porosity of less than 40%, preferably a porosity of less than 20%. The porosity may be determined from the difference between the theoretical density and the measured density.

Preferably, the process for preparing the active material formulation includes a step of forming a sulfur-carbon composite, said preliminary step of forming the sulfur-carbon composite including melting of a sulfur-based material and blending of the molten sulfur-based material and of the carbon-based fillers. Such a step enables the formation of a homogeneous mixture.

However, as the melting of the mixture is limited by the difference in density between the carbon-based fillers (0.05-0.5 g/cm³) and the sulfur (2 g/cm³), it is necessary to add intense mechanical energy to perform this mixing, which may be between 0.05 kWh/kg and 1 kWh/kg of active material, preferably between 0.2 and 0.5 kWh/kg of active material. The carbon-based fillers are thus dispersed homogeneously throughout the bulk, and are not found solely at the surface of the sulfur-based particles. To do this, use is preferentially made of a compounding device, i.e. an apparatus conventionally used in the plastics industry for the melt blending of thermoplastics and additives for the purpose of producing composites. A process for preparing a sulfur-carbon composite via the molten route that is particularly advantageous in the context of the invention is described in WO 2016/102865.

Advantageously, the sulfur-carbon composite is obtained via a manufacturing process including a step of melting the sulfur-based material and of blending the molten sulfur-based material and carbon-based fillers. This melting and blending step may be advantageously performed with a compounding device. Thus, as presented in FIG. 1, the process 100 according to the invention may include preliminary steps of forming the sulfur-carbon composite, said steps of forming the sulfur-carbon composite including:
introduction 110 into a compounding device of at least one sulfur-based material and of carbon-based fillers,
optionally, a step 120 of introducing an additive,
performing a compounding step 130 so as to allow the melting of the sulfur-based material, and
blending 140 the molten sulfur-based material and the carbon-based fillers.

To do this, use is preferentially made of a compounding device, i.e. an apparatus conventionally used in the plastics industry for the melt blending of thermoplastic polymers and additives for the purpose of producing composites. The active material according to the invention may thus be prepared according to a process also comprising the recovery 150 of the sulfur-carbon composite obtained in an agglomerated solid physical form.

The introduction step 110 is performed in a compounding apparatus. The sulfur-based material and the carbon-based fillers are mixed using a high-shear device, for example a co-rotating twin-screw extruder or a co-kneader. The molten material generally leaves the apparatus in an agglomerated solid physical form, for example in the form of granules, or in the form of rods which, after cooling, are chopped into granules.

Examples of co-kneaders that may be used are the Buss® MDK co-kneaders and those of the Buss® MKS or MX series, sold by the company Buss AG, which all consist of a screw shaft provided with flights which is positioned in a heating barrel optionally consisting of several parts, the internal wall of which is provided with kneading teeth suitable for working with the flights so as to shear the material. The shaft is driven in rotation and is provided with an oscillating movement in the axial direction by a motor. These co-kneaders may be equipped with a system for manufacturing granules, for example adapted to their outlet orifice, which may consist of an extrusion screw or a pump. The co-kneaders that may be used according to the invention preferably have an L/D screw ratio ranging from 7 to 22, for example from 10 to 20, whereas co-rotating extruders advantageously have an L/D ratio ranging from 15 to 56, for example from 20 to 50.

Preferably, the active material formulation also comprises at least one additive chosen from a rheology modifier, a binder, an ion conductor, another carbon-based electrical conductor, an electrolyte, an electron-donating element or a combination thereof. Thus, the process may include a step 120 of introducing at least one additive. Just like the carbon-based fillers, the additive(s) may be incorporated into the active material formulation via the molten route, for example during step 120.

These additives are advantageously introduced before or during the compounding step, so as to obtain a homogeneous active material formulation. In this embodiment, the sulfur-based material and the electrically conductive composition then represent from 50% to 99% by weight, preferably from 60% to 95% by weight relative to the total weight of the active material formulation.

In particular, it is possible to add, during the mixing, before or during the compounding step, a rheology modifier, i.e. an additive which lowers the rheology of the sulfur in molten form, so as to reduce the self-heating of the mixture in the compounding device. Such additives are described in patent application WO 2013/178930. Examples that may be mentioned include dimethyl sulfide, diethyl sulfide, dipropyl sulfide, dibutyl sulfide, the trisulfide homologs thereof, the tetrasulfide homologs thereof, the pentasulfide homologs thereof, the hexasulfide homologs thereof, alone or as mixtures of two or more thereof in any proportions.

The amount of rheology-modifying additive is generally between 0.01% and 5% by weight, preferably from 0.1% to 3% by weight, with respect to the total weight of the active material formulation.

The active material formulation may comprise a binder, notably a polymeric binder. Polymeric binders may also provide a certain amount of dimensional plasticity or flexibility to the electrode formed from the active material. Advantageously, these binders are introduced before or during the compounding step. In addition, an important role of the binder is also to ensure homogeneous dispersion of the active material and, for example, of the sulfur-carbon composite particles. Various polymeric binders may be used in the formulation according to the invention and they may be chosen, for example, from halogenated polymers, preferably fluoropolymers, functional polyolefins, polyacrylonitriles, polyurethanes, polyacrylic acids and derivatives thereof, polyvinyl alcohols and polyethers, and a mixture thereof in all proportions.

Examples of fluoropolymers that may be mentioned include poly(vinylidene fluoride) (PVDF), preferably in the alpha form, poly(trifluoroethylene) (PVF₃), polytetrafluoroethylene (PTFE), copolymers of vinylidene fluoride with either 1 hexafluoropropylene (HFP) or trifluoroethylene (VF3) or tetrafluoroethylene (TFE) or chlorotrifluoroethylene (CTFE), fluoroethylene/propylene (FEP) copolymers, copolymers of ethylene with either fluoroethylene/propylene (FEP) or tetrafluoroethylene (TFE) or chlorotrifluoroethylene (CTFE), perfluoropropyl vinyl ether (PPVE), perfluoroethyl vinyl ether (PEVE), 2,3,3,3-tetrafluoropropene and copolymers of ethylene with perfluoromethyl vinyl ether (PMVE), or mixtures thereof.

Examples of polyethers that may be mentioned include poly(alkylene oxide)s, such as poly(ethylene oxide)s PEOs, polyalkylene glycols, such as polyethylene glycols PEGs, polypropylene glycols PPGs, polytetramethylene glycols (PTMGs), polytetramethylene ether glycols (PTMEGs), etc.

The polymeric binders may also be selected from block copolymers of these polymers such as a copolymer containing PEO/PPO/PEO blocks. More preferably, the polymeric binder is PVDF or a PEO. POE is occasionally used in acetonitrile or isopropanol, and likewise PTFE in suspension in ethanol or water. The most common polymer remains poly(vinylidene fluoride) (PVDF), used in solution in N-methyl-2-pyrrolidone (NMP). This polymer is chemically stable with respect to the organic electrolyte, but also electrochemically stable in the potential window of Li/S accumulators. It does not dissolve in organic solvents, swells very little, and thus enables the electrode to conserve its morphology and its mechanical strength during cycling.

Possible binders are also those of the polysaccharide family such as carboxymethylcellulose (CMC), hydroxyethylcellulose (HEC), etc. Preferably, the binder is PVDF, PEO or CMC.

The amount of binder is generally less than 20% by weight relative to the active material formulation and is preferably between 5% and 15% by weight.

The active material formulation may comprise an ion conductor having a favorable interaction with the surface of the sulfur or of the sulfur-based molecule, so as to increase the ion conductivity of the active material. Examples of ion conductors that may be mentioned, in a nonlimiting manner, include lithium organic salts, for example lithium imidazolate salts. Mention may also be made of poly(alkylene oxide)s, which, besides their role as binder, may provide ion conductivity properties to the active material.

The active material formulation may also comprise another electrical conductor, advantageously a carbon-based electrical conductor, such as carbon black, graphite or graphene, generally in proportions which may range from 1% to 10% relative to the sulfur-based molecule. Preferably, carbon black is used as electrical conductor. The active material formulation may comprise an electron-donating element to improve the electron exchanges and to regulate the length of the polysulfides during charging, which optimizes the charging/discharging cycles of the battery. Use may advantageously be made, as electron-donating elements, of an element, in powder form or in salt form, from groups IVa, Va and VIa of the Periodic Table, preferably chosen from Se, Te, Ge, Sn, Sb, Bi, Pb, Si or As.

These compounds may generally be added in proportions that may range from 1% to 10% by weight relative to the weight of sulfur-based material.

The active material formulation may also comprise an electrolyte salt preferably selected from: lithium (bis)trifluoromethanesulfonate imide (LiTFSI), lithium 2-trifluoromethyl-4,5-dicyanoimidazole (LiTDI), lithium bis(fluorosulfonyl)imide (LiFSI), lithium hexafluorophosphate (LiPF₆), lithium perchlorate (LiClO₄), lithium trifluoromethylsulfonate (CF₃SO₃Li), lithium trifluoroacetate (CF₃COOLi), lithium dodecafluorododecaborate (Li₂B₁₂F₁₂), lithium bis(oxalate)borate (LiBC₄O₈) and lithium tetrafluoroborate (LiBF₄). More preferably, the electrolyte liquid solvent includes LiTFSI.

The compounding step 130 is performed at a temperature above the melting point of the sulfur-based material. In the case of elemental sulfur, the compounding temperature may range from 120° C. to 150° C. In the case of other types of sulfur-based material, the compounding temperature depends on the material specifically used, the melting point of which is generally given by the supplier of the material. The residence time will also be adapted to the nature of the sulfur-based material.

This process makes it possible to efficiently and homogeneously disperse a large amount of carbon-based fillers in the sulfur-based material, despite the difference in density between the constituents of the active material formulation.

In order to achieve optimal dispersion of the carbon-based fillers in the sulfur-based material in the compounding device, it is necessary to apply a large amount of mechanical energy, which is preferably greater than 0.05 kWh/kg of material.

In the case where the compounding is performed in an extruder, the active material formulation is advantageously obtained in the form of extrudates, the diameter of which may be between 0.5 and 5 mm.

The process may comprise a step 140 of blending the molten sulfur-based material and the carbon-based fillers. The blending may be performed by any kneading, blending or extrusion device known to those skilled in the art and compatible with the active material formulation, notably with the temperature during the compounding step.

The mixture of particles may then be milled, during a milling step 160, to obtain a powder not containing any particles with a size of greater than 100 microns, preferably no particles with a size of greater than 25 microns, so as to facilitate the electrode manufacturing process. The carbon-based fillers are mixed with the sulfur-based molecule(s), in particular with sulfur, preferably via the molten route. The milling step may be performed in the solid state, in other words in a dry form.

The step of milling the sulfur-carbon composite may be performed, for example, in a jar mill (horizontal and vertical with a cage), a cavitator, a jet mill, a fluidized bed jet mill, a liquid-phase mill, a screw disperser, a brush mill, a hammer mill, a ball mill, or by other methods for the micronization of solid materials.

In addition, the inventors have developed a process for preparing a formulation for the manufacture of an electrode from a sulfur-carbon composite which is capable of improving the charging and discharging capacity and of improving the interfaces by performing the milling in a liquid-phase solvent including, for example, electrolyte salts and/or solid electrolytes. As will be detailed hereinbelow, the creation, from the milling step, of favorable interfaces can make it possible to improve the performance of the active material formulation. More particularly, milling in the presence of an electrolyte makes it possible directly to obtain the catholyte. This catholyte can then be used to form the cathode.

As presented in FIG. 2, the improved milling process according to the invention comprises the following steps:
Introduction 210 into a milling device of a liquid-phase solvent,
Introduction 220 into the milling device of a sulfur-carbon composite, said sulfur-carbon composite including at least one sulfur-based material and carbon-based fillers,
Performing 230 a milling step,
Producing 240, following said milling step, an active material formulation in the form of a solid-liquid dispersion, including the sulfur-carbon composite in the form of particles with a median diameter D50 of less than 50 μm.

Steps 210 and 220 prior to the milling step 230 are presented in a certain order in FIG. 2. However, in the context of the invention, the order of introduction of the substances into the mill can be modified without this being able to be considered as being another invention.

As presented in FIG. 2, the process according to the invention includes a step 210 of introducing a liquid-phase solvent into a milling device.

Preferably, the amount of solvent used makes it possible to form a solid-liquid dispersion having a weight content of solid of less than 90%, preferably less than 80%, more preferably between 30% and 60%.

The solvent used during the milling step may be a solvent that can be evaporated off before the manufacture of the electrode. In this case, the solvent is preferably selected from liquid-phase solvents with a boiling point of less than 300° C., preferably less than or equal to 200° C., more preferably less than or equal to 115° C., even more preferably less than or equal to 100° C. Thus, the solvent can be evaporated off after the milling step without bringing about a modification of the carbon-sulfur composite.

In this context, the liquid-phase solvent used in the invention may include, for example, at least one protic or aprotic solvent, said protic or aprotic solvent being selected from: water, alcohols, ethers, esters, lactones, N-methyl-2-pyrrolidone and dimethyl sulfoxide.

Alternatively, the liquid-phase solvent used is water or an alcohol and the solvent is removed by means of a lyophilization step.

In addition, preferably, the liquid-phase solvent is degassed before it is introduced into the milling device.

As presented in FIG. 2, the process according to the invention includes a step 220 of introducing a sulfur-carbon composite into the milling device.

The sulfur-carbon composite includes at least one sulfur-based material and carbon-based fillers.

The sulfur-carbon composite, before the milling step, may be in the form of solids, or solid materials, with a median diameter D50 of greater than 50 μm.

The sulfur-carbon composite used during the milling step may be obtained via several processes and has a form and dimensions defined by its production route. Advantageously, the sulfur-carbon composite is obtained via a manufacturing process including a step of melting a sulfur-based material and of blending the molten sulfur-based material and carbon-based fillers, preferably in the presence of intense mechanical energy. This melting and blending step may be advantageously performed with a compounding device. The sulfur-carbon composite is generally in agglomerated physical form, for example in the form of granules. In this case, the form of the granules will depend on the diameter of the holes of the die and on the speed of the knives. The granules may have, for example, at least one dimension between 0.5 mm and several millimeters.

Thus, preferably, the sulfur-carbon composite is in the form of solids such as granules or particles with a median diameter D50 of greater than 100 μm, preferably greater than 200 μm and more preferably greater than 500 μm.

The sulfur-carbon composite advantageously used in the context of the invention comprises carbon-based fillers percolated in a molten sulfur-based matrix, and the carbon-based fillers are homogeneously distributed throughout the bulk of the sulfur-based material, which can be visualized, for example, by electron microscopy. The sulfur-based material/carbon-based filler mixture has a morphology suited to optimization of the functioning of an Li/S battery electrode. The carbon-based fillers are thus dispersed homogeneously throughout the bulk of the particles, and are not found solely at the surface of the sulfur-based particles.

The active material according to the invention, namely an active material based on this sulfur-carbon composite, may thus provide an efficient transfer of electricity from the current collector of the electrode and offer active interfaces to the electrochemical reactions during the functioning of the battery.

As presented in FIG. 2, the process according to the invention includes a milling step 230.

Milling in the liquid state has the advantage of not creating excessively high porosity in the active material obtained. Thus, the powder obtained has a higher density than powders obtained via conventional methods.

The milling step may be performed, for example, in a jar mill (horizontal and vertical with a cage), a cavitator, a jet mill, a fluidized bed jet mill, a liquid-phase mill, a screw disperser, a brush mill, a hammer mill, a ball mill, or by other methods for the micronization of solid materials.

The milling step is generally performed over a period of 30 minutes or more. Preferably, the milling step is performed over a period of 1 hour or more, more preferably at least 2 hours.

Advantageously, the process according to the invention may include two successive milling steps, performed on two different milling devices.

The milling step is generally performed at a temperature below the boiling point of the liquid-phase solvent. Advantageously, the milling step is performed at a temperature below the melting point of the sulfur-based material. The milling step is preferably performed at a temperature below 300° C., more preferably at a temperature below 200° C., even more preferably at a temperature of less than or equal to 110° C.

In addition, contrary to prior art processes, the milling step is preferably performed at a temperature above 0° C. More preferably, it is performed at a temperature above 10° C.

Thus, the milling step is performed at a temperature of between 1° C. and 300° C., preferably between 5° C. and 200° C. and more preferably between 5° C. and 110° C. When the term “between” is used, it should be understood that the limits are included. The milling step will probably generate heating of the mixture caused by the friction to which the milling step gives rise. Thus, self-heating is accepted up to the desired temperature, then the process may comprise a step of cooling the mixture, notably to remain at a temperature below the boiling point of the liquid-phase solvent used.

If this is necessary, the milling step may be followed by a step of mixing the solid-liquid dispersion with additives, which may be other components of the electrode, preferably via the liquid route.

As presented in FIG. 2, the process according to the invention includes a step 240 of obtaining a formulation in the form of a solid-liquid dispersion generated during the milling step. In addition, this formulation includes the sulfur-carbon composite in the form of particles with a median diameter D50 of less than 50 μm and advantageously less than 10% by number of the particles of the dispersion are particles of sulfur in elemental form.

The formulation in the form of a solid-liquid dispersion as defined according to the invention makes it possible to increase the specific capacity of the electrode, and to increase the charging and discharging capacity of the electrode. The formulation according to the invention can thus provide efficient transfer of electricity from the current collector of the electrode and offer active interfaces to the electrochemical reactions during the functioning of the battery.

As presented in FIG. 2, the process according to the invention includes a drying step 250. The drying step 250 enables the generation of an active material formulation in the form of a powder. The active material formulation obtained from the solid-liquid dispersion then advantageously has a moisture content of less than 100 ppm.

This drying step may be performed, for example, via an atomization step. This active material powder has advantages in common with the formulation, namely improved performance by means of a low content of sulfur in elemental form and/or low oxidation. This powder may then be formulated with conventional additives and used in the dry route.

The active material formulation in powder form according to the invention comprises particles presenting an intimate mixture of carbon-based fillers dispersed in the bulk of the sulfur-based material, in a homogeneous manner. The active material formulation advantageously has a density of greater than 1.6 g/cm³, determined according to the standard NF EN ISO 1183-1.

It also advantageously has a porosity of less than 20%, which may be determined from the difference between the theoretical density and the measured density. The active material formulation according to the invention, preferably in powder form as characterized previously, and advantageously having a porosity of less than 20% and/or a density of greater than 1.6 g/cm³, may be used for preparing an electrode, in particular a cathode, of an Li/S battery. The active material generally represents from about 20% to 95% by weight, preferably from 35% to 80% by weight relative to the full formulation of the electrode.

In addition, the heat of fusion of the sulfur-based material in the sulfur-carbon composite forming the active material according to the invention is lower than the heat of fusion of the sulfur-based material found in formulations or active materials formed according to methods of the prior art. Thus, preferably, the sulfur-based material of the sulfur-carbon composite has a heat of fusion, as measured by differential scanning calorimetry between 80° C. and 130° C. (e.g. 5° C./minute under a stream of nitrogen), at least 10% less than the heat of fusion of the sulfur-based material used for the formation of the sulfur-carbon composite, more preferably at least 15% less and more preferably at least 20% less. It would not constitute a departure from the scope of the invention should the sulfur-carbon composite not have a heat of fusion of the sulfur-based material of between 80° C. and 130° C., i.e. in the case where it is amorphous.

Advantageously, the sulfur-based material of the sulfur-carbon composite has a heat of fusion, as measured by differential scanning calorimetry between 80° C. and 130° C. (e.g. 5° C./minute under a stream of nitrogen), of less than 60 J.g⁻¹, preferably less than 55 J.g⁻¹ and more preferably less than 50 J.g⁻¹.

According to another aspect, the invention relates to a catholyte comprising an active material formulation according to the invention and a binder.

Preferably, the binder is notably selected from: acrylic polymers, methacrylic polymers, fluoropolymers, polyethers, polyesters, polysaccharides such as cellulose and derivatives thereof, notably CMC, functional polyolefins, polyethyleneimines, polyacrylonitriles, polyurethanes, polyvinyl alcohols, polyvinylpyrrolidones, copolymers thereof, and mixtures thereof.

The catholyte also comprises at least one additive chosen from: a rheology modifier, an ion conductor, another carbon-based electrical conductor, an electrolyte and an electron-donating element. The catholyte may comprise one or more of each of these additives. These additives have already been described previously; thus, the catholyte according to the invention may include the additives described previously, notably the preferred additives.

The electrolyte is preferably selected from LiNO₂, LiFSI, LiTFSI, LiTDI and other Li salts, and mixtures thereof. More preferably, the electrolyte comprises LiFSI, LiTFSI and/or LiTDI. In addition, at least a portion of the electrolyte may be an ion-conducting ceramic or solid electrolyte.

The carbon-based electrical conductor is preferably chosen from carbon blacks, acetylene blacks, graphites, graphene, carbon nanofibers, carbon fibers, active charcoals, intrinsically conductive polymers, and mixtures thereof. Specifically, there are fibers and/or nanofibers, preferably carbon fibers, in the active material formulation according to the invention, but there is the possibility of once again adding such fibers or nanofibers to the catholyte.

In addition, the catholyte according to the invention may include a liquid solvent that is capable of dissolving at least one electrolyte salt, also referred to as an electrolyte liquid solvent. The electrolyte liquid solvent may be selected, for example, from: a monomer, an oligomer, a polymer and a mixture thereof. In particular, the liquid-phase solvent includes at least one compound selected from: water, an amide, a carbonate ester, an ether, a sulfone, a fluoro compound, toluene and dimethyl sulfoxide. The amide is preferably N-methyl-2-pyrrolidone (NMP) or N,N-dimethylformamide (DMF).

The electrolyte liquid solvent is preferably a solvent that is suitable for lithium-sulfur batteries; in this case, it is not necessary to perform an evaporation step after the milling step, and this allows direct formulation of the cathode. Thus, preferably, the liquid-phase solvent includes at least one compound selected from: a carbonate ester, an ether, a sulfone, a fluoro compound and toluene.

Carbonate esters may be used as electrolyte liquid solvents. Ethers notably make it possible to obtain good dissolution of lithium polysulfides and, although having dielectric constants that are generally lower than those of carbonates, ether-type solvents offer relatively high ion conductivities and a capacity for solvating lithium ions.

Thus, preferably, the electrolyte liquid solvent is an ether such as 1,3-dioxolane (DIOX) or 1,2-dimethoxyethane (DME) or a carbonate ester such as dimethyl carbonate (DMC) or propylene carbonate (PC).

The electrolyte liquid solvent may also include a combination of solvents. For example, it may comprise an ether and a carbonate ester. This may make it possible to reduce the viscosity of a mixture including a high molecular weight carbonate ester.

Preferably, the electrolyte liquid solvent is selected from: 1,3-dioxolane (DIOX), 1,2-dimethoxymethane (DME), ethylene carbonate (EC), diethyl carbonate (DEC), propylene carbonate (PC), dimethyl carbonate (DMC), ethyl methyl carbonate (EMC), methyl propyl carbonate, tetrahydrofuran (THF), 2-methyltetrahydrofuran, methyl propyl propionate, ethyl propyl propionate, methyl acetate, diglyme (2-methoxyethyl ether), tetraglyme, diethylene glycol dimethyl ether (diglyme, DEGDME), polyethylene glycol dimethyl ether (PEGDME), tetraethylene glycol dimethyl ether (TEGDME), ethylene carbonate, propylene carbonate, butyrolactone, dioxolane, hexamethyl phosphoamide, pyridine, dimethyl sulfoxide, tributyl phosphate, trimethyl phosphate, N-tetraethylsulfamide, sulfone, and mixtures thereof.

More preferably, the electrolyte liquid solvent is selected from: tetrahydrofuran, 2-methyltetrahydrofuran, dimethyl carbonate, diethyl carbonate, ethyl methyl carbonate, methyl propyl carbonate, methyl propyl propionate, ethyl propyl propionate, methyl acetate, dimethoxyethane, 1,3-dioxolane, diglyme(2-methoxyethyl ether), tetraglyme, ethylene carbonate, propylene carbonate, butyrolactone, dioxolane, hexamethyl phosphoamide, pyridine, dimethyl sulfoxide, tributyl phosphate, trimethyl phosphate, N-tetraethylsulfamide, sulfone, and mixtures thereof.

Other solvents may also be used, for instance sulfones, fluoro compounds or toluene.

Preferably, the solvent is a sulfone or a mixture of sulfones. Examples of sulfones are dimethyl sulfone and sulfolane. Sulfolane may be used as sole solvent or as a combination, for example, with other sulfones. In one embodiment, the electrolyte liquid solvent comprises lithium trifluoromethanesulfonate and sulfolane.

The invention also relates to the use of the active material formulation as described previously in an electrode, in particular in a Li/S battery cathode. The active material according to the invention makes it possible to improve the electron conductivity of the electrode formulation, the mechanical integrity of the electrode and thus the functioning over time of the battery.

Thus, according to another aspect, the invention relates to the use of the formulation according to the invention for the manufacture of an electrode, in particular a cathode.

To do this, the formulation, in the form of a particulate mixture, may be deposited on the current collector.

The active material formulation may be applied to the current collector in the form of a suspension in a solvent (for example water or an organic solvent). The solvent can then be removed, for example by drying, and the resulting structure blocked to form a composite structure, which can be cut into the desired shape to form a cathode.

In one embodiment, the cathode comprises 1% to 5% by weight of PEO and 1% to 5% by weight of a binder chosen from gelatin, a cellulose (for example carboxymethylcellulose) and/or a rubber (for example styrene-butadiene rubber). Such binders can improve the lifetime of the cell. The use of such binders can also make it possible to reduce the total amount of binder, for example to levels of 10% by weight of the total weight of the cathode or less.

The cathode described herein may be used in a lithium-sulfur cell.

According to another aspect, the present invention provides a lithium/sulfur accumulator, or lithium-sulfur cell, comprising a cathode as described above.

The lithium/sulfur accumulator may also comprise an anode comprising an alloy of lithium metal or of lithium metal and an electrolyte.

The electrolyte may be a solid electrolyte or may comprise at least one lithium salt and at least one organic solvent.

Optionally, a separator may be positioned between the cathode and the anode. For example, during the assembly of the cell, a separator may be placed in the cathode and a lithium anode placed on the separator. The electrolyte may then be introduced into the assembled cell to wet the cathode and the separator. As a variant, the electrolyte may be applied to the separator, for example by coating or spraying, before the lithium anode is placed on the separator. The separator is generally composed of a porous membrane of polyolefins (polyethylene, polypropylene). This element is used only in combination with a liquid electrolyte, since polymeric or gelled electrolytes already ensure by themselves the physical separation of the electrodes. When a separator is present in the cell of the present invention, the separator may comprise any suitable porous membrane or substrate which allows the ions to move between the electrodes of the cell. The separator must be positioned between the electrodes to prevent direct contact between the electrodes. The porosity of the substrate must be at least 30%, preferably at least 50%, for example greater than 60%. Suitable separators comprise a lattice formed from a polymer material. The suitable polymers comprise polypropylene, nylon and polyethylene. Nonwoven polypropylene is particularly preferred. It is possible to use a multilayer separator. The separator may comprise carbon-based fillers. The separator may be Li-Nafion.

As discussed above, the cell comprises an electrolyte. The electrolyte is present or arranged between the electrodes, which allows the charge to be transferred between the anode and the cathode. Preferably, the electrolyte wets the pores of the cathode and also, for example, the pores of the separator. The organic solvents that may be used in the electrolyte are those described above as electrolyte liquid solvents.

The examples hereinbelow illustrate the invention but do not have any limiting nature.

### EXAMPLES

### Example 1: Preparation of an S/Nanotubes Active Material Formulation

Nanotubes (Graphistrength® C100 from ARKEMA) and solid sulfur (50-800 microns) were introduced into the first feed hopper of a Buss® 25 M DK 46 co-kneader (L/D=11) equipped with a discharge extrusion screw and a granulation device.

The nominal temperature values in the co-kneader were as follows: Zone 1: 140° C.; Zone 2: 130° C.; Screw: 120° C. At the die outlet, the mixture, consisting of 87.5% by weight of sulfur and 12.5% by weight of nanotubes, is in the form of granules obtained by pelletizing, cooled with air.

### Example 2

Graphistrength® C100 nanotubes from the company Arkema (diameter 15 nm, length 1 to 10 nm, apparent density 0.08), VGCF H nanofibers from the company Showa Denko (diameter 150 nm, length of 10 to 20 microns, apparent density 0.08) and solid sulfur (50-800 microns) were introduced into the first feed hopper of a Buss® 25 MDK 46 co-kneader (L/D=11), equipped with a discharge extrusion screw and a granulation device.

The nominal temperature values in the co-kneader were as follows: Zone 1: 140° C.; Zone 2: 130° C.; Screw: 120° C. At the die outlet, the mixture, consisting of 87.5% by weight of sulfur, 10% by weight of nanotubes and 2.5% by weight of nanofibers, is in the form of granules obtained by pelletizing, cooled with air.

### Example 3

Graphistrength® C100 carbon nanotubes from the company Arkema (diameter 15 nm, length 1 to 10 nm, apparent density 0.08), sulfur and fibers chopped to 5 mm obtained by carbonization under N₂ of viscose fibers between 180 and 1200° C., with a residence time of 15 minutes, are introduced into the first feed hopper of a Buss® 25 MDK 46 co-kneader (L/D=11), equipped with a discharge extrusion screw and a granulation device. The specific density of the fibers is 1.45 and their diameter is between 1 and 5 μm. At the die outlet, the mixture, consisting of 87.5% by weight of sulfur, 10% by weight of nanotubes and 2.5% by weight of ex viscose fibers, is in the form of granules obtained by pelletizing, cooled with air.

### Example 4

Example 2 is repeated, but using a conductor consisting of 60% of Graphistrength® C100 nanotubes and 40% of VGCF H nanofibers. The other parameters are unchanged.

### Example 5

Example 2 is repeated, but using a conductor consisting of 40% of Graphistrength® C100 nanotubes and 60% of VGCF H nanofibers. The other parameters are unchanged.

### Example 6

Example 2 is repeated, but using a conductor consisting of 20% of Graphistrength® C100 nanotubes and 80% of VGCF H nanofibers. The other parameters are unchanged.

### Example 7

Example 2 is repeated, but using a conductor consisting of 100% of VGCF H nanofibers. The other parameters are unchanged.

### Example 8

A composite is prepared with a content of conductor equal to 20% (12% nanotubes and 8% nanofibers) and a sulfur content equal to 80%. The other parameters are unchanged.

### Example 9

A composite is prepared with a content of conductor equal to 20% (12% nanotubes and 8% ex viscose carbon fibers) and a sulfur content equal to 80%. The other parameters are unchanged.

### Example 10

A composite is prepared with the composition: 87.5% sulfur, 7.5% nanotubes and 5% nanofibers.

### Example 11

The formulation is prepared with 80% sulfur, 10% carbon nanotubes, 5% VGCF H nanofibers and 5% ex viscose carbon fibers.

### Example 12: Evaluation of the Active Material Formulation

The tests were performed in an Li/S battery model containing:

1) Anode made of Li metal, thickness 100 microns

2) Separator/membrane (20 microns)

3) Electrolyte based on sulfolane with 1M of Li+

4) Cathode based on a sulfur-based formulation supported by a collector made of Al

The following cathode formulations, serving as reference, were tested:

reference formulation comprising, by weight, 70% of sulfur, 10% of carbon black and 20% of PEO (Polyox WSR N-60K), representative of the prior art. [Comparative example 1]

formulation comprising, by weight, 80% of active material of example 1, 5% of carbon black and 15% of PEO. [Comparative example 2]

reference formulation comprising, by weight, 70% of sulfur, 15% of carbon nanotubes and 15% of PEO. [Comparative example 3]

The other formulations are expressed as 100% of sulfur plus conductive additive to which are added 15% of PEO.

The cathode formulations are applied to the electrode via a paste in a solvent, followed by drying and pressing.

The capacity of the cathode of the test cell is between 1.5 and 3 mAh/cm². The test cells were placed under charging/discharging conditions. The performance of the cathode was evaluated after 150 cycles and is reported in the table below.

TABLE 1

| | | | Perfor- |
|---|---|---|---|
| | | Initial | mance |
| | | perfor- | after 150 |
| | Cathode | mance | cycles |
| Comparative | 70% sulfur − 10% carbon | 100 | 78 |
| example 1 | black − 20% PEO | | |
| Comparative | 70% sulfur − 10% carbon | 100 | 88 |
| example 2 | nanotubes + 5% carbon | | |
| | black − 15% PEO | | |
| Comparative | 70% sulfur − 15% carbon | 100 | 86 |
| example 3 | nanotubes − 15% PEO | | |
| Example 1 | 87.5% sulfur − 12.5% | 100 | 83 |
| (ref.) | nanotubes | | |
| Example 2 | 87.5% sulfur − 10% | 100 | 87 |
| | nanotubes and 2.5% | | |
| | nanofibers | | |
| Example 3 | 87.5% sulfur − 10% | 100 | 85 |
| | nanotubes and 2.5% | | |
| | fibers | | |
| Example 4 | 87.5% sulfur − 7.5% | 100 | 92 |
| | nanotubes and 5% | | |
| | nanofibers | | |
| Example 5 | 87.5% sulfur − 5% | 100 | 91 |
| | nanotubes and 7.5% | | |
| | nanofibers | | |
| Example 6 | 87.5% sulfur − 2.5% | 100 | 87 |
| | nanotubes and 10% | | |
| | nanofibers | | |
| Example 7 | 87.5% sulfur − 12.5% | 100 | 83 |
| | nanofibers | | |
| Example 8 | 80% sulfur − 12% | 100 | 95 |
| | nanotubes and 8% | | |
| | nanofibers | | |
| Example 9 | 80% sulfur − 12% | 100 | 95 |
| | nanotubes and 8% | | |
| | carbon fibers | | |
| Example 10 | 87.5% sulfur − 7.5% | 100 | 93 |
| | nanotubes and | | |
| | 5% nanofibers | | |
| Example 11 | 80% sulfur − 10% | 100 | 97 |
| | nanotubes and 5% | | |
| | nanofibers and 5% | | |
| | carbon fibers | | |

These results confirm that the active material formulation according to the invention, including carbon-based fillers, makes it possible to improve the lifetime and thus the efficiency of an Li/S battery, especially when certain ratios between nanotubes and nanofibers are applied.

In addition, as may be seen by comparing the cycling stability of the compositions according to examples 2 and 4, the stability is still substantially increased when the conductive composition includes more than 20% of carbon nanofibers and more preferably 40% or more of carbon nanofibers. Furthermore, in the presence of carbon fiber, the performance is also improved, as evidenced by examples 3 and 9. Specifically, the presence of the carbon fibers makes it possible to ensure performance after 150 cycles that is largely superior to that of a composition comprising only CNTs. Finally, the cycling stability is improved when the electrically conductive composition includes at least 20% of carbon fibers and even more so when the electrically conductive composition includes at least 40% of carbon fibers.

Similarly, as may be seen by comparing the cycling stability of the compositions according to examples 4 and 6, the stability is still substantially increased when the conductive composition includes more than 20% of carbon nanotubes and more preferably 40% or more of carbon nanotubes.

As illustrated in examples 4, 5 and 6, the decrease in the amount of nanotubes in favor of an increase in carbon nanofibers decreases the performance after 150 cycles. According to examples 2 and 6, the performance is identical independently of the amount of carbon nanotubes relative to the amount of carbon nanofibers, whereas, in the presence of carbon nanotubes and carbon fibers, the performance is improved even after 150 cycles. In addition, with regard to examples 3 and 9, this performance is improved when the amount of carbon nanotubes and of carbon fibers increases. Thus, in the presence of carbon fibers and of carbon nanotubes, the performance is improved particularly when the composition comprises more than 20% of carbon fibers.

Finally, the best results are obtained with the combination of carbon nanotubes, carbon nanofibers and carbon fibers (example 11) and notably when the conductive composition includes 25% or more of carbon nanofibers and 25% or more of carbon fibers.

1. An active material formulation comprising a sulfur-based material and an electrically conductive composition, wherein the electrically conductive composition comprises carbon nanotubes and carbon fibers.

2. The active material formulation as claimed in claim 1, wherein the electrically conductive composition also comprises carbon nanofibers.

3. The active material formulation as claimed in claim 1, wherein the electrically conductive composition also comprises another carbon-based filler selected from the group consisting of carbon blacks, acetylene blacks, graphites, graphenes, active charcoals, and mixtures thereof.

4. The active material formulation as claimed in claim 1, wherein the sulfur-based material and the electrically conductive composition are in a mass ratio of between 1/4 and 50/1.

5. The active material formulation as claimed in claim 1, wherein the carbon nanotube content is at least 20% by weight of the conductive composition.

6. The active material formulation as claimed in claim 1, wherein at least a portion of the carbon nanofibers, carbon nanotubes and/or carbon fibers is covered with an intrinsically conductive polymer.

7. The active material formulation as claimed in claim 1, wherein at least a portion of the carbon nanofibers, carbon nanotubes and/or carbon fibers is covered with an ion-conducting ceramic material.

8. The active material formulation as claimed in claim 1, wherein the sulfur-based material has a S8 content of less than 10% by weight of the sulfur-based material.

9. A catholyte comprising an active material formulation as claimed in claim 1 and a binder.

10. The catholyte as claimed in claim 9, wherein the catholyte also comprises at least one additive selected from the group consisting of a rheology modifier, an ion conductor, another carbon-based electrical conductor, an electrolyte and an electron-donating element.

11. A process for preparing the active material formulation as claimed in claim 1, comprising a step of placing the sulfur-based material in contact with the electrically conductive composition.

12. The preparation process as claimed in claim 11, wherein the step of placing in contact is selected from: mixing the sulfur-based material with the electrically conductive composition at a temperature greater than or equal to the melting point of the sulfur-based material, sublimation of the sulfur-based material on the electrically conductive composition, liquid-phase deposition of the sulfur-based material on the electrically conductive composition.

13. The preparation process as claimed in claim 11, wherein the process includes a preliminary step of forming a sulfur-carbon composite, said preliminary step including melting a sulfur-based material and blending the molten sulfur-based material and carbon-based fillers.

14. The preparation process as claimed in claim 11, wherein the process comprises a step of milling the sulfur-carbon composite, said milling step being performed in a jar mill (horizontal and vertical with a cage), a cavitator, a jet mill, a fluidized bed jet mill, a liquid-phase mill, a screw disperser, a brush mill, a hammer mill, a ball mill, or by other micronization methods.

15. The preparation process as claimed in claim 11, wherein the process comprises the following steps:
introducing into a milling device a liquid-phase solvent and a sulfur-carbon composite said sulfur-carbon composite including at least one sulfur-based material and carbon-based fillers,
implementing a milling step,
producing, following said milling step, a formulation in the form of a solid-liquid dispersion including the sulfur-carbon composite,
optionally implementing a drying step.

16. A cathode prepared from the catholyte as claimed in claim 9.

17. A lithium/sulfur accumulator comprising a cathode as claimed in claim 16.
